(19) United States
(12) Patent Application Publication
(10) Pub. No.: US 2013/0098815 A1
(43) Pub. Date: Apr. 25, 2013

(54) SEWAGE TREATMENT APPARATUS

(71) Applicants: Jeung-Yeun Cho, Chungcheongnam-do (KR); Kyung-In Jeong, Seoul (KR)

(72) Inventors: Jeung-Yeun Cho, Chungcheongnam-do (KR); Kyung-In Jeong, Seoul (KR)

(73) Assignees: DONG LIM ENG CO., LTD., Seoul (KR); DREAM ENGINEERING CO., LTD., Chungcheongnam-do (KR)

(21) Appl. No.: 13/806,675

(22) PCT Filed: Jan. 19, 2011
(86) PCT No.: PCT/KR11/00390

§ 371 Date: Dec. 21, 2012

(51) Int. Cl. C02F 3/30

(52) U.S. Cl. CPC C02F 3/30
USPC 210/151

(57) ABSTRACT

The present invention relates to a sewage treatment apparatus, more specifically to a sewage treatment apparatus which does not only supply high quality treated water with uniform diffusion of microorganism mixed liquor suspended solids (MLSS) and organic matters during hydraulic retention time (HRT), but also provides the target quality of treated water by adaptively treating changes in the quality of inflow water and properly removing nitrogen and phosphorus without the need for internal recycling.

### FIELD

The present invention relates to a sewage treatment apparatus, and more particularly, to a sewage treatment apparatus which does not only supply high quality treated water with uniform diffusion of microorganism mixed liquor suspended solids (MLSS) and organic matters during hydraulic retention time (HRT), but also provides the target quality of treated water by adaptively treating changes in the quality of inflow water and properly removing nitrogen and phosphorus without the need for internal recycling.

### BACKGROUND

Conventionally, sewage and wastewater are treated to an appropriate level of a chemical oxygen demand (COD) and a biological oxygen demand (BOD), but with the rising issue of eutrophication due to nitrogen and phosphorus within the sewage, regulations for the amount of nitrogen and phosphorus contained in the treated water discharged from a sewage treatment apparatus have been introduced and are becoming more stringent.

Generally, a facility for biologically processing nitrogen and phosphorus in the wastewater or sewage consists of a bioreactor and a sedimentation tank. The bioreactor is comprised of an anaerobic zone, an anoxic zone, an aerobic zone, and the like, or the combination thereof.

To biologically process nitrogen, an aerobic zone and an anoxic zone are primarily required, and once the oxidation of ammonia nitrogen takes place in the aerobic zone, nitrate, which is a result of the oxidation, is denitrified to nitrogen gas by heterotrophic microorganisms that use the nitrate as electron acceptor in the anoxic zone, and thereby the nitrate is removed.

Further, to biologically process phosphorus, an anaerobic zone and an aerobic zone are primarily required. Phosphate accumulating organisms (PAOs) that accumulate phosphorus within their cells synthesize polyhydroxy alkanoate (PHA) using volatile organic acids while releasing phosphorus in the anaerobic zone, and then the PAOs accumulate phosphorus within their cells in the aerobic zone while growing using the produced PHA. The PAO accumulating phosphorus is discharged together with sludge and thereby the phosphorus is removed from the treated water.

Facilities for simultaneously biologically treating nitrogen and phosphorus have been developed using these principles, and examples of such facilities are illustrated in FIGS. 1 and 2.

FIG. 1 is a schematic diagram of a conventional sewage treatment plant using A2O system and FIG. 2 is a schematic diagram of a conventional sewage treatment plant using DNR system.

Referring to FIG. 1, the conventional sewage treatment plant using A2O system has a relatively simple structure, consisting of an anaerobic reactor, an anoxic reactor, an aerobic reactor, and a sedimentation tank, which are sequentially arranged, so as to remove nitrogen and phosphorus from sewage.

In A2O system, sludge may flow back into the anaerobic reactor, into which the sewage flows, from the sedimentation tank through a return sludge pipe, and thus there may be a problem of reduced efficiency of phosphorus removal due to quite a quantity of nitrate contained in the sludge.

That is, since organic acids contained in the influent sewage and readily biodegradable COD are consumed by denitrifying microorganisms before being used by PAOs in the anaerobic reactor, the PAOs cannot synthesize a sufficient amount of PHA within their cells in the anaerobic reactor, and are thus unable to absorb phosphorus in the aerobic reactor, and consequently the phosphorus cannot be removed and is discharged together with treated water.

Specifically, the A2O system cannot avoid degradation in efficiency of phosphorus removal from general domestic sewage with a high total Kjeldahl nitrogen (TKN)/COD ratio and low RBCOD content.

To address the above-mentioned drawbacks of the A2O system, the arrangement of the bioreactors including the anaerobic reactor, the anoxic reactor, and the aerobic reactor has been changed, or an A2O similar system that includes more additional bioreactors has been developed. In addition, a method (Korean Patent Registration No. 375413) of providing additional external carbon sources to a system to increase RBCOD content within an anaerobic reactor and thereby removing nitrogen and phosphorus has been introduced.

However, the above-suggested methods still have a fundamental problem that returns sludge containing nitrate from the sedimentation tank to the anaerobic reactor, and hence there is a limitation in phosphorus removal efficiency.

As a solution for the drawbacks identified above, the DNR system has been developed by changing the layout of an anaerobic reactor and an anoxic reactor in the A2O system in such a manner that sludge in a sedimentation tank is returned to anoxic reactor 1, instead of being returned to the anaerobic reactor, which has been believed as the fundamental problem of the A2O or similar systems. In addition, as shown in FIG. 2, the DNR system includes an additional anoxic reactor 2, and hence consists of anoxic reactor 1, the anaerobic reactor, anoxic reactor 2, the aerobic reactor, and the sedimentation tank which are arranged in this order.

In the sewage treatment plant using DNR system shown in FIG. 2, since nitrate contained in sludge of the sedimentation tank is transferred to the anaerobic reactor after denitrification in anoxic reactor 1, the nitrate does not affect the PAOs' absorption of organic matters in the anaerobic reactor, and thereafter the PAOs are enabled to grow in the aerobic reactor and excess consumption of phosphorus by the PAOs can take place, resulting in an increase in phosphorus removal efficiency.

However, slow denitrification is accepted as a drawback of the DNR system of the sewage treatment plant, which is caused by endogenous respiration of the PAOs using their own organic substances in anoxic reactor 1. In treatment of general domestic sewage, a speed of denitrification using organic matters in the influent water is 0.04˜0.15 g NO3—N/gVSS (volatile suspended solid)/day, whereas it is known that a speed of denitrification by endogenous respiration of the POAs is only about 20% to 50% of the nitrification using organic matters in the influent water.

Hence, there is a need for a new sewage treatment apparatus which not only supplies high quality treated water with uniform diffusion of microorganism mixed liquor suspended solids (MLSS) and organic matters during hydraulic retention time (HRT), but also provides the target quality of treated water by adaptively treating changes in the quality of inflowing water and properly removing nitrogen and phosphorus without internal recycling.

### DETAILED DESCRIPTION

### Technical Problem

The objective of the present invention is to provide a sewage treatment apparatus which not only supplies high quality treated water with uniform diffusion of microorganism mixed liquor suspended solids (MLSS) and organic matters during hydraulic retention time (HRT), but also provides the target quality of treated water by adaptively treating changes in the quality of inflow water and properly removing nitrogen and phosphorus without the need for internal recycling.

### Technical Solution

The present invention provides a sewage treatment apparatus including: a grit chamber configured to remove solids and remove contaminants of high specific gravity from influent sewage by settling the contaminants to a bottom; a primary sedimentation tank configured to remove floating substances of low specific gravity from sewage passing through the grit chamber by settling the floating substances to a bottom; a bioreactor configured to biologically process sewage passing through the primary sedimentation tank; and a secondary sedimentation tank configured to filter out activated sludge from sewage passing through the bioreactor, feed aerobic microorganisms back to the bioreactor, and filter out dissoluble sludge from resultant liquid, wherein the bioreactor is configured to comprise a first aerobic reactor configured to treat the sewage passing through the primary sedimentation tank, an anoxic reactor configured to process sewage passing through the first aerobic tank, an anaerobic tank configured to treat sewage passing through the anoxic reactor and a second aerobic reactor to treat sewage passing through the anaerobic reactor, and the first aerobic reactor receives influent water from the primary sedimentation tank connected with the first aerobic reactor and returned water from the secondary sedimentation tank for maintaining the number of microorganisms in the first aerobic reactor, the secondary sedimentation tank being disposed in a different direction from the primary sedimentation tank, and includes a flash mixer to quickly mix the influent water and the returned water.

The sewage treatment apparatus may further include an anoxic-reactor-dedicated influent feed pipe configured to comprise a plurality of first nozzles arranged at regular and uniform distances from one another on a perimeter of the influent feed pipe to supply organic sources required for denitrification to an inside of the anoxic reactor.

The sewage treatment apparatus may further include an anoxic-reactor-dedicated slow mixer placed in the anoxic reactor and configured to slowly mix treated water in the anoxic reactor and to thereby maintain a substantially uniform concentration of denitrifying microorganisms throughout the entire treated water within the anoxic reactor.

The sewage treatment apparatus may further include an anaerobic-reactor-dedicated influent feed pipe configured to supply carbon sources required for action of phosphorus removal microorganisms to an inside of the anaerobic reactor and to comprise a plurality of second nozzles arranged at regular and uniform distances from one another on a circumference of the anaerobic reactor.

The sewage treatment apparatus may further include an anaerobic-reactor-dedicated slow mixer placed in the anaerobic reactor and configured to slowly mix treated water in the anaerobic reactor and to thereby maintain a substantially uniform concentration of phosphorus removal microorganisms throughout the entire treated water within the anaerobic reactor.

The sewage treatment apparatus may further include at least one partition provided to form a stabilization pond in the second aerobic reactor and configured to prevent overflow and maintain an effluent flow velocity of treated water of the second aerobic reactor within a predetermined range and to thereby increase a nitrification rate.

The first aerobic reactor and the second aerobic reactor may include a first air diffuser and a second air diffuser, respectively, and each air diffuser may include a number of air holes through which air flows into the corresponding aerobic reactor from a ventilator.

A number of bulkheads may be provided between the first aerobic reactor, the anoxic reactor, the anaerobic reactor, and the second aerobic reactor, and a number of treated water flowing grooves are formed on the respective bulkheads in such a manner that they are arranged in an up- and down-stream direction wherein the grooves appear alternately on upper and lower portions of the corresponding bulkheads.

### Advantageous Effects

According to exemplary embodiments of the present invention, a sewage treatment apparatus does not only supply high quality treated water with uniform diffusion of microorganism mixed liquor suspended solids (MLSS) and organic matters during hydraulic retention time (HRT), but also provides the target quality of treated water by adaptively treating changes in the quality of inflow water and properly removing nitrogen and phosphorus without internal recycling.

### BRIEF DESCRIPTION OF THE DRAWINGS

FIG. 1 is a schematic diagram of a conventional sewage treatment plant using A2O system.

FIG. 2 is a schematic diagram of a conventional sewage treatment plant using DNR system.

FIG. 3 is a diagram illustrating a sewage treatment system including a sewage treatment apparatus according to an exemplary embodiment of the present invention.

FIG. 4 is a diagram illustrating a top view of a sewage treatment apparatus according to an exemplary embodiment of the present invention.

FIG. 5 is a diagram illustrating a longitudinal section profile of the sewage treatment apparatus of FIG. 4.

Explanation of Reference numerals designating
the Major Elements of the Drawings

| | |
|---|---|
| 10: First air diffuser | 12: Flash mixer |
| 21: Anoxic-reactor-dedicated | 22: First nozzle |
| influent feed pipe | |
| 23: Anoxic-reactor-dedicated | 31: Anaerobic-reactor-dedicated |
| slow mixer | influent feed pipe |
| 32: Second nozzle | 33: Anaerobic-reactor-dedicated |
| | slow mixer |
| 40: Second air diffuser | 11, 41: Air hole |
| 51~54: Bulkhead | 60: Partition |

### MODE FOR INVENTION

Hereinafter, exemplary embodiments of the present invention will be described with reference to the accompanying drawings.

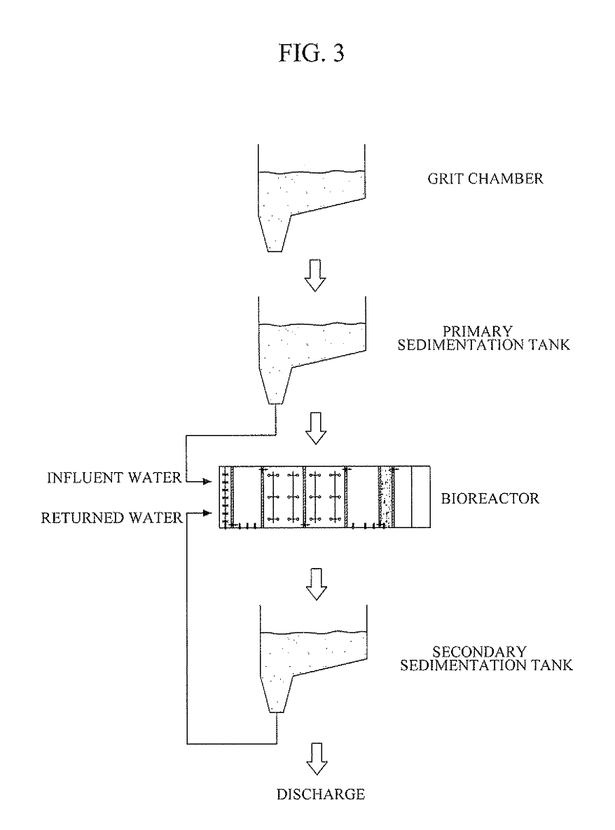

FIG. 3 is a diagram illustrating a sewage treatment system including a sewage treatment apparatus according to an exemplary embodiment of the present invention.

Referring to FIG. 3, a general sewage treatment system mainly includes a grit chamber, a primary sedimentation tank, a bioreactor, and a secondary sedimentation tank, and sewage and wastewater is discharged after passing through these basins for treatment.

FIG. 3 illustrates an example of a typical sewage treatment system, and the system may further include an additional chamber according to conditions of the area and a quality of water. For example, the system may further include an additional chamber for removing chlorine from sewage. Configurations of each tank will be described in brief.

The grit chamber filters out large volume solid waste, such as plastic bags, paper, and wooden debris, from sewage and allows heavy solids, such as sand and gravel, to settle to the bottom while the influent sewage passes through a mesh screen.

The primary sedimentation tank is regarded as a physical treatment, in which sedimentation of floating particles of low specific gravity takes place and floating grease and lighter particles are removed.

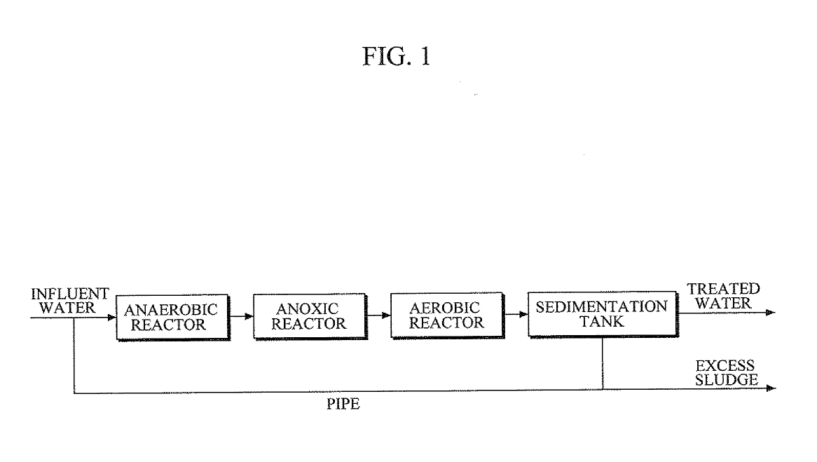

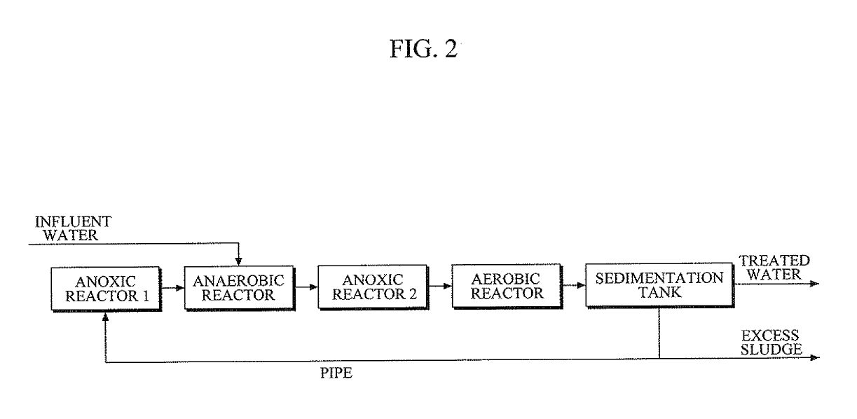

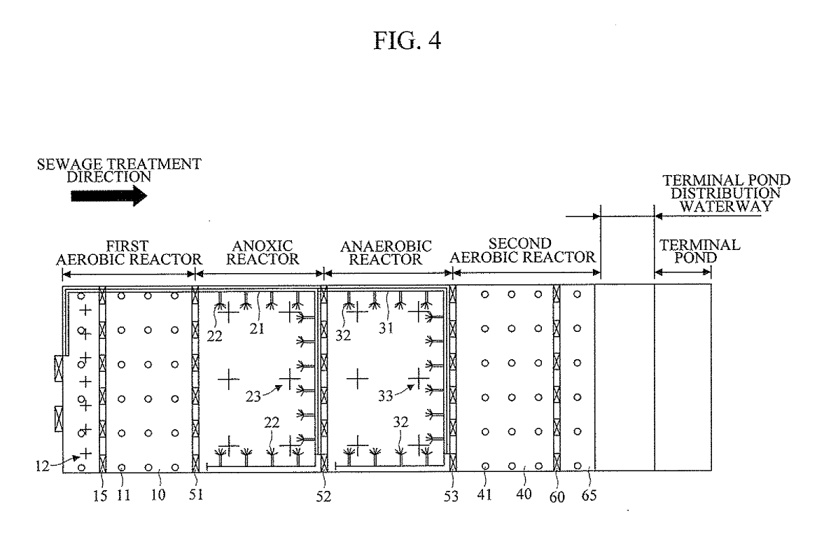

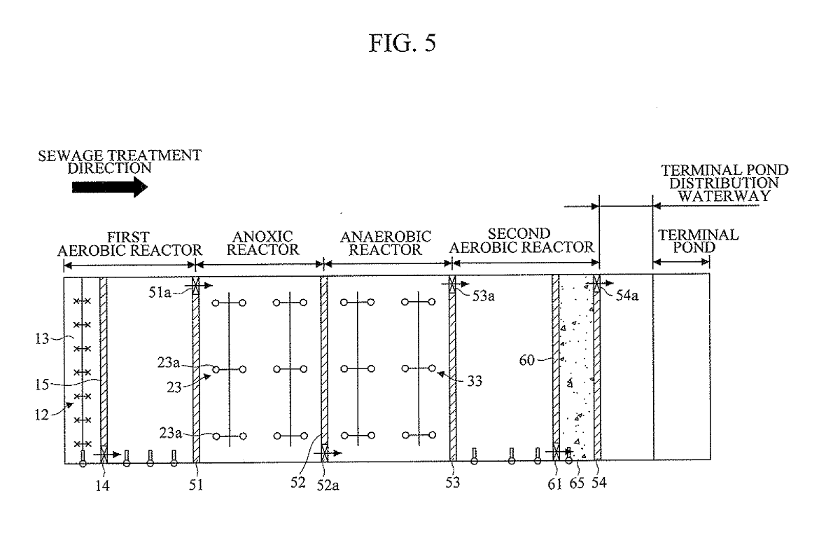

The bioreactor is also called an aerobic tank or a biological treatment tank. FIGS. 1 and 2 show a configuration of a bioreactor according to the related art, and the sewage treatment apparatus which will be described hereinafter in detail is a bioreactor. The sewage treatment apparatus as a bioreactor will be described later with reference to FIGS. 4 and 5.

In the secondary sedimentation tank, activated sludge is filtered out and aerobic microorganisms are fed back to the bioreactor, and suspended sludge is removed. The activated sludge is a mixture of sediment produced during dissolving stage and microorganisms. The aerobic microorganisms use oxygen in the decomposition of organic substance to obtain energy.

FIG. 4 is a diagram illustrating a top view of a sewage treatment apparatus according to an exemplary embodiment of the present invention. FIG. 5 is a diagram illustrating a longitudinal section profile of the sewage treatment apparatus of FIG. 4.

As shown in FIGS. 4 and 5, the sewage treatment apparatus includes a grit chamber, a primary sedimentation tank, a bioreactor, and a secondary sedimentation tank. The grit chamber may remove solids and the contaminants of high specific gravity by allowing the contaminants to settle to the bottom. Lighter solids of low specific gravity settle at the bottom of the primary sedimentation tank, thereby being removed from the sewage influent from the grit chamber. The bioreactor biologically treats the sewage having passed through the primary sedimentation tank, and the secondary sedimentation tank filters activated sludge from the effluent of the bioreactor and feeds back aerobic microorganisms to the bioreactor, and filters out suspended sludge. The bioreactor includes a first aerobic reactor to treat the sewage passing through the primary sedimentation tank, an anoxic reactor to treat the sewage passing through the first aerobic reactor, an anaerobic reactor to treat the sewage passing through the anoxic reactor, and the second aerobic reactor to treat the sewage passing through the anaerobic reactor, and these reactors are arranged close to each other in the direction of sewage treatment flow. Hence, the bioreactor of the sewage treatment apparatus according to the exemplary embodiment of the present invention includes four steps including the first aerobic reactor, the anoxic reactor, the anaerobic reactor, and the second aerobic reactor, which are closely arranged close to each other.

For convenience of illustration, no particular reference numerals are assigned to the first aerobic reactor, the anoxic reactor, the anaerobic reactor, and the second aerobic reactor. The roles and configurations of each reactor will be described below.

The first aerobic reactor is a reactor which provides an environment for microorganisms to decompose contaminants (organic matters, etc.) under aerobic condition (where oxygen exists). For example, an aquarium may be such an aerobic reactor, and oxygen is constantly supplied to the first aerobic reactor, and thereby the contaminants can decompose.

The first aerobic reactor includes a first air diffuser 10 with a number of air holes 11 through which the air flows into the first aerobic reactor from a ventilator which is not illustrated. However, the present invention is not necessarily limited to the above, and an air blower may be provided instead of the first air diffuser 10.

The first aerobic reactor receives influent water from the connected primary sedimentation tank and returned water from the secondary sedimentation tank, which is disposed in a different direction from the primary sedimentation tank, so as to maintain the number of microorganisms in the first aerobic reactor. The first aerobic reactor includes flash mixers 12 to quickly mix the influent water and the returned water. Referring to FIG. 3, the returned water from the secondary sedimentation tank is a means for maintaining the number of microorganisms in the first aerobic reactor.

The flash mixer 12 is provided to quickly mix the influent water and the returned water so as to immediately create an environment optimal for the microorganisms to feed and decompose organic matter, in which soluble ingredients and colloidal organic matter being supplied from the influent water from the primary sedimentation tank and the returned water from the secondary sedimentation tank are evenly distributed to biological flock growing in suspension in the first aerobic reactor and thereby a uniformly dispersed concentration of organic matter in the first aerobic reactor is achieved. The flash mixer 12 may be an agitator whose motor speed is increased.

The flash mixer 12 may be, but not necessarily, disposed inside a partitioned area 13 which includes an opening 14 in the first aerobic reactor. The opening 14 may be preferably formed on a lower portion of a bulkhead 15 in the aerobic reactor.

A first bulkhead 51 is formed between the first aerobic reactor and the anoxic reactor, including a first treated water flowing groove 51a on its upper portion. Resultant treated water from the first aerobic reactor flows into the first anoxic reactor through the first treated water flowing groove 51a on the upper portion of the first aerobic reactor. By leading the flow of the treated water in an upper direction, the retention time of water in the first aerobic reactor may be maximized, and thus biochemical oxygen demand (BOD) may be removed from the water influent to the anoxic reactor in which the action of denitrifying microorganisms can be expected, and the efficiency of mixing oxygen with the sewage may be increased.

The anoxic reactor is a reactor in which denitrification of returned nitrified mixed liquor suspended solids (MLSS) takes place. The anoxic reactor is connected with an anoxic-reactor-dedicated influent feed pipe 21 having a number of first nozzles 22. The anoxic-reactor-dedicated influent feed pipe 21 may supply organic sources required for the denitrification to the anoxic reactor through the first nozzles 22.

In this case, the anoxic-reactor-dedicated influent feed pipe 21 is disposed along the circumference of the anoxic reactor so as to uniformly deliver the organic sources to the anoxic reactor, and the first nozzles 22 are arranged at uniform distances from each other on the perimeter of the influent feed pipe 21.

The anoxic reactor includes anoxic-reactor-dedicated slow mixers 23 to slowly mix the treated water to maintain the substantially uniform concentration of denitrifying microorganisms throughout the treated water in the anoxic reactor.

The anoxic-reactor-dedicated slow mixer 23 refers to a mixer with a slower motor speed than that of the flash mixer 12. The operation of the slow mixer 23 contributes to maintaining the uniform concentration of microorganisms throughout the entire area of the anoxic reactor. As schematically illustrated in drawings, the anoxic-reactor-dedicated slow mixers 23 have a number of agitating blades 23a according to the height.

A second bulkhead 52 is provided between the anoxic reactor and the anaerobic reactor, and a second treated water flowing groove 52a is formed on a lower portion of the second bulkhead 52. The treated water from the anoxic reactor flows into the anaerobic reactor through the second treated water flowing groove 52a at the lower portion.

The anaerobic reactor is a reactor which provides an environment for microorganisms to decompose contaminants (organic matters, etc.) under anaerobic condition (where no oxygen exists). A septic tank is an example of the anaerobic reactor. That is, the anaerobic reactor is a unit to process organic matters using microorganisms that inhabit anaerobic environments, and it differs from the aerobic reactor in that an aeration unit is not provided since oxygen is inhibited.

Additionally, a DO concentration in the anaerobic reactor is maintained to an anaerobic level such that phosphorous removal bacteria or microorganisms can release phosphorus as much as possible in the anaerobic reactor so as to be able to excessively consume the released phosphorus in the next reactor, the second aerobic reactor.

The anaerobic reactor is connected with an anaerobic-reactor-dedicated influent feed pipe 31 which includes a number of second nozzles 32. The anaerobic-reactor-dedicated influent feed pipe 31 acts to feed carbon sources required for the action of phosphorous removal bacteria or microorganisms to the anaerobic reactor.

In this case, to evenly disperse the carbon sources in the anaerobic reactor, the influent feed pipe 31 is disposed along the circumference of the anaerobic reactor, and the plurality of second nozzles 32 are arranged at regular and uniform distances from each other on the perimeter of the influent feed pipe 31. The anaerobic-reactor-dedicated influent feed pipe 31 may be on the same line as or different line from the anoxic-reactor-dedicated influent feed pipe 21.

In addition, the anaerobic reactor includes an anaerobic-reactor-dedicated slow mixer 33 to slowly mix treated water in the anaerobic reactor such that a concentration of phosphorous removal bacteria or microorganisms can be substantially uniform over the treated water in the anaerobic reactor. The operation of the slow mixer 33 may contribute to maintaining the uniform concentration of microorganisms throughout the entire anaerobic reactor. The anaerobic-reactor-dedicated slow mixer 33 may be the same as the anoxic-reactor-dedicated slow mixer 23.

A third bulkhead 53 may be provided between the anaerobic reactor and the second aerobic reactor, and include a third treated water flowing groove 53a at an upper portion. The treated water in the anaerobic reactor flows into the second aerobic reactor through the third treated water flowing groove 53a.

The second aerobic reactor is provided to maximize a nitrification rate. That is, the bacteria or microorganisms that have released phosphorus in the anaerobic reactor are encouraged to consume as much phosphorous as possible in the second aerobic reactor.

The second aerobic reactor includes a second air diffuser 40 with a number of air holes 41 through which the air flows into the second aerobic reactor from the ventilator, which is not illustrated. However, the present invention is not necessarily limited to the above, and an air blower may be provided instead of the first air diffuser 40.

A partition 60 is provided in the second aerobic reactor to increase the nitrification rate by preventing overflow and maintaining a predetermined range of effluent flow velocity of the treated water in the second aerobic reactor. The partition 60 includes a treated water flowing groove 61 at a lower portion. A stabilization pond which is formed by the partition 60 in the second aerobic reactor can prevent the overflow and ensure an appropriate retention time of the water, thereby maximizing the nitrification rate.

At a rear end of the second aerobic reactor, a terminal pond distribution waterway and a terminal pond are disposed. A fourth bulkhead 54 is provided between the terminal pond distribution pond and the second aerobic reactor, and includes a fourth treated water flowing groove 54a at an upper portion. The treated water in the second aerobic reactor flows into the terminal pond distribution waterway through the fourth treated water flowing groove 54a at the upper portion of the second aerobic reactor.

Accordingly, the treated water flowing through the first aerobic reactor, the anoxic reactor, the anaerobic reactor, the second aerobic reactor and the terminal pond distribution waterway passes through the flowing grooves 51a, 52a, 53a, 54a, and 61 which are arranged in an up- and down-stream direction. The arrangement in the up- and down-stream direction allows water to flow alternately up and down.

Operation of the sewage treatment apparatus according to the exemplary embodiments of the present invention described above will be described hereinafter.

Influent water from the grit chamber and the primary sedimentation tank and returned water from the secondary sedimentation tank flow into the first aerobic reactor, and then they are quickly mixed and the mixture flows into an anoxic reactor from an upper portion of the first aerobic reactor.

Then, denitrification to release nitrogen takes place in the anoxic reactor. During the denitrification, organic sources for the nitrification are delivered through the anoxic-reactor-dedicated influent feed pipe 21, and the anoxic-reactor-dedicated slow mixer 23 maintains a uniform concentration of microorganisms across the entire anoxic reactor.

The wasted water in the anoxic reactor flows into the anaerobic reactor from the lower portion, and phosphorus removal occurs in the anaerobic reactor. During the phosphorus removal, carbon sources required for the action of phosphorus removal bacteria or microorganisms are delivered through the anaerobic-reactor-dedicated influent feed pipe 31, and the anaerobic-reactor-dedicated slow mixer 33 maintains a uniform concentration of microorganisms across the entire anaerobic reactor.

The treated water in the anaerobic reactor flows into the second aerobic reactor from the upper portion, and the stabilization pond 65 within the second aerobic reactor ensures an appropriate retention time of the treated water, thereby maintaining an effluent flow velocity of the treated water within a predefined range. Thus, the nitrification rate can be maximized. The treated water after maximizing the nitrification rate flows to the terminal pond distribution waterway and the terminal pond.

The water, after chemical treatment in the bioreactor, flows into the secondary sedimentation tank which filters out activated sludge. The secondary sedimentation tank feeds back the aerobic microorganisms to the bioreactor and filters suspended sludge from the remaining liquid and discharge the treated water.

As described above, according to the exemplary embodiments of the present invention, the sewage treatment apparatus does not only supply high quality treated water with uniform diffusion of microorganism mixed liquor suspended solids (MLSS) and organic matters during hydraulic retention time (HRT), but also provides the target quality of treated water by adaptively treating changes in the quality of inflow water and properly removing nitrogen and phosphorus without the need for internal recycling.

In fact, under the condition where HRT is 6-8 hours, a solid retention time (SRT) is 10-15 days, MLSS is 2500-3500 mg/l and a return sludge rate is 50-100%, a simulation performed showed that treatment efficiency of BOD, COD, suspended solid (SS), and T-N and T-P is over 98%, over 95%, over 98%, and 85%, respectively.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A sewage treatment apparatus comprising:
a grit chamber configured to remove solids and remove contaminants of high specific gravity from influent sewage by settling the contaminants to a bottom;
a primary sedimentation tank configured to remove floating substances of low specific gravity from sewage passing through the grit chamber by settling the floating substances to a bottom;
a bioreactor configured to biologically process sewage passing through the primary sedimentation tank; and
a secondary sedimentation tank configured to filter out activated sludge from sewage passing through the bioreactor, feed aerobic microorganisms back to the bioreactor, and filter out dissoluble sludge from resultant liquid,
wherein the bioreactor is configured to comprise a first aerobic reactor configured to treat the sewage passing through the primary sedimentation tank, an anoxic reactor configured to process sewage passing through the first aerobic tank, an anaerobic tank configured to treat sewage passing through the anoxic reactor and a second aerobic reactor to treat sewage passing through the anaerobic reactor, and the first aerobic reactor receives influent water from the primary sedimentation tank connected with the first aerobic reactor and returned water from the secondary sedimentation tank for maintaining the number of microorganisms in the first aerobic reactor, the secondary sedimentation tank being disposed in a different direction from the primary sedimentation tank, and includes a flash mixer to quickly mix the influent water and the returned water.

2. The sewage treatment apparatus of claim 1, further comprising:
an anoxic-reactor-dedicated influent feed pipe comprising a plurality of first nozzles arranged at regular and uniform distances from one another on a perimeter of the influent feed pipe to supply organic sources required for denitrification to an inside of the anoxic reactor.

3. The sewage treatment apparatus of claim 2, further comprising:
an anoxic-reactor-dedicated slow mixer placed in the anoxic reactor and configured to slowly mix treated water in the anoxic reactor and to maintain a substantially uniform concentration of denitrifying microorganisms throughout the entire treated water within the anoxic reactor.

4. The sewage treatment apparatus of claim 1, further comprising:
an anaerobic-reactor-dedicated influent feed pipe configured to supply carbon sources required for action of phosphorus removal microorganisms to an inside of the anaerobic reactor and to comprise a plurality of second nozzles arranged at regular and uniform distances from one another on a circumference of the anaerobic reactor.

5. The sewage treatment apparatus of claim 4, further comprising:
an anaerobic-reactor-dedicated slow mixer placed in the anaerobic reactor and configured to slowly mix treated water in the anaerobic reactor and to maintain a substantially uniform concentration of phosphorus removal microorganisms throughout the entire treated water within the anaerobic reactor.

6. The sewage treatment apparatus of claim 1, further comprising:
at least one partition provided to form a stabilization pond in the second aerobic reactor and configured to prevent overflow and maintain an effluent flow velocity of treated water of the second aerobic reactor within a predetermined range and to increase a nitrification rate.

7. The sewage treatment apparatus of claim 1, wherein the first aerobic reactor and the second aerobic reactor include a first air diffuser and a second air diffuser, respectively, and each air diffuser includes a number of air holes through which air flows in from a ventilator.

8. The sewage treatment apparatus of claim 1, wherein a number of bulkheads are provided between the first aerobic reactor, the anoxic reactor, the anaerobic reactor, and the second aerobic reactor, and a number of treated water flowing grooves are formed on the respective bulkheads in such a manner that they are arranged in an up- and down-stream direction wherein the grooves appear alternately on upper and lower portions of the corresponding bulkheads.

9. The sewage treatment apparatus of claim 2, wherein a number of bulkheads are provided between the first aerobic reactor, the anoxic reactor, the anaerobic reactor, and the second aerobic reactor, and a number of treated water flowing grooves are formed on the respective bulkheads in such a manner that they are arranged in an up- and down-stream direction wherein the grooves appear alternately on upper and lower portions of the corresponding bulkheads.

10. The sewage treatment apparatus of claim 3, wherein a number of bulkheads are provided between the first aerobic reactor, the anoxic reactor, the anaerobic reactor, and the second aerobic reactor, and a number of treated water flowing grooves are formed on the respective bulkheads in such a manner that they are arranged in an up- and down-stream direction wherein the grooves appear alternately on upper and lower portions of the corresponding bulkheads.

11. The sewage treatment apparatus of claim 4, wherein a number of bulkheads are provided between the first aerobic reactor, the anoxic reactor, the anaerobic reactor, and the second aerobic reactor, and a number of treated water flowing grooves are formed on the respective bulkheads in such a manner that they are arranged in an up- and down-stream direction wherein the grooves appear alternately on upper and lower portions of the corresponding bulkheads.

12. The sewage treatment apparatus of claim 5, wherein a number of bulkheads are provided between the first aerobic reactor, the anoxic reactor, the anaerobic reactor, and the second aerobic reactor, and a number of treated water flowing grooves are formed on the respective bulkheads in such a manner that they are arranged in an up- and down-stream direction wherein the grooves appear alternately on upper and lower portions of the corresponding bulkheads.

13. The sewage treatment apparatus of claim 6, wherein a number of bulkheads are provided between the first aerobic reactor, the anoxic reactor, the anaerobic reactor, and the second aerobic reactor, and a number of treated water flowing grooves are formed on the respective bulkheads in such a manner that they are arranged in an up- and down-stream direction wherein the grooves appear alternately on upper and lower portions of the corresponding bulkheads.

14. The sewage treatment apparatus of claim 7, wherein a number of bulkheads are provided between the first aerobic reactor, the anoxic reactor, the anaerobic reactor, and the second aerobic reactor, and a number of treated water flowing grooves are formed on the respective bulkheads in such a manner that they are arranged in an up- and down-stream direction wherein the grooves appear alternately on upper and lower portions of the corresponding bulkheads.
